(19) United States
(12) Patent Application Publication
(10) Pub. No.: US 2014/0371392 A1
(43) Pub. Date: Dec. 18, 2014

(54) Polymeric Materials Modified By Silanes

(71) Applicant: Dow Corning Corporation, Midland, MI (US)

(72) Inventors: Michael Wolfgang Backer, Mainz (DE); Thomas Chaussee, Fontaines Saint Martin (FR); Damien Deheunynck, Tavaux (FR); Gina Di Giovanni, Haine-Saint-Pierre (BE); Fabien Rialland, Bruxelles (Ixelles) (BE)

(21) Appl. No.: 14/362,611

(22) PCT Filed: Dec. 7, 2012
(86) PCT No.: PCT/EP2012/074732

§ 371 Date: Jun. 4, 2014

(30) Foreign Application Priority Data
Dec. 8, 2011 (GB) 1121130.7

(51) Int. Cl. C08C 19/25

(52) U.S. Cl. CPC C08C 19/25
USPC 525/102

(57) ABSTRACT

This invention relates to a process for modifying a polymeric material having a carbon backbone containing carbon-to-carbon unsaturation by reaction with a hydrolysable silane. The polymeric material can for example be a diene elastomer, and the invention relates to a composition comprising a diene elastomer, a hydrolysable silane and a curing agent for the diene elastomer, and also to the use of a hydrolysable silane as a coupling agent for a diene elastomer composition containing a filler.

This invention relates to a process for modifying a polymeric material having a carbon backbone containing carbon-to-carbon unsaturation by reaction with a hydrolysable silane. The polymeric material can for example be a diene elastomer, and the invention relates to a composition comprising a diene elastomer, a hydrolysable silane and a curing agent for the diene elastomer, and also to the use of a hydrolysable silane as a coupling agent for a diene elastomer composition containing a filler.

WO-A-2010/139473 describes various hydrolysable silanes as coupling agents between an inorganic filler and an elastomer. The silanes include those containing a heterocyclic ring such as N-(3-triethoxysilylpropyl)-dihydroimidazole and 1-(3-triethoxysilylpropyl)-pyrrole.

Other examples of hydrolysable silanes which have been proposed as coupling agents include unsaturated silanes containing an ester group, such as an acryloxypropyltrialkoxysilane, described in WO-A-2010/125124.

US-A-2010/056713 describes a conjugated diene polymer comprising a conjugated diene-based constituent unit and an aminosilane constituent unit, at least one terminus of the polymer being modified by an alkoxysilane compound comprising a nitrogen atom-containing functional group. The alkoxysilane compound can for example contain a dialkylamino group, a di(alkoxyalkyl)amino group, a di(alkylene oxide) amino group, a di(alkylene oxide alkyl)amino group, or a di(trialkylsilyl)amino group.

WO2011/083050 describes a process for grafting silane or silicone functionality onto a diene elastomer, comprising reacting the diene elastomer with an unsaturated monomer (A) containing an olefinic —C═C— bond or acetylenic —C≡C— bond and a reactive functional group X with an organosilicon compound (B) having a functional group Y which is reactive with the functional group X of the unsaturated monomer (A), characterized in that the unsaturated monomer (A) has the formula R″—CH═CH—Z (I) or R″—C≡C—Z (II) in which Z represents an electron-withdrawing moiety containing the reactive functional group X and R″ represents hydrogen or a group having an electron withdrawing effect or any other activation effect with respect to the —CH═CH— or —C≡C— bond.

In a process according to one aspect of the present invention for modifying a polymeric material having a carbon backbone containing carbon-to-carbon unsaturation by reaction with a hydrolysable silane, the hydrolysable silane is a silane of the formula

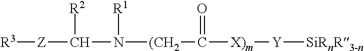

wherein each R represents a hydrolysable group; each R″ represents a hydrocarbyl group having 1 to 8 carbon atoms; n=1 to 3; Y represents a divalent organic spacer linkage having 1 to 20 carbon atoms; X represents —O— or —NH—; m=0 or 1; R² represents hydrogen or a hydrocarbyl or substituted hydrocarbyl group having 1 to 8 carbon atoms; Z represents an oxygen or sulphur atom; R³ represents a hydrocarbyl or substituted hydrocarbyl group having 1 to 20 carbon atoms; and R¹ represents a hydrocarbyl or substituted hydrocarbyl group having 1 to 20 carbon atoms other than a group of the formula R³—Z—CH(R²)— as defined above.

In a process according to another aspect of the present invention for modifying a polymeric material having a carbon backbone containing carbon-to-carbon unsaturation by reaction with a hydrolysable silane, characterised in that the hydrolysable silane is a silane of the formula G-OC(O)-(Az)-J wherein G and J each represent a hydrocarbyl or substituted hydrocarbyl group having 1 to 40 carbon atoms, at least one of G and J being a group of the formula RₐR″₃₋ₐSi-A in which R represents a hydrolysable group; R″ represents a hydrocarbyl group having 1 to 8 carbon atoms; a has a value in the range 1 to 3 inclusive; Az represents an aziridine ring bonded to the group J through its nitrogen atom; and A represents a divalent organic spacer linkage having at least one carbon atom.

The invention includes a diene elastomer composition comprising a diene elastomer, a hydrolysable silane and a curing agent for the diene elastomer, characterised in that the hydrolysable silane is a hydrolysable silane of the formula

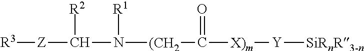

wherein each R represents a hydrolysable group; each R″ represents a hydrocarbyl group having 1 to 8 carbon atoms; n=1 to 3; Y represents a divalent organic spacer linkage having 1 to 20 carbon atoms; X represents —O— or —NH—; m=0 or 1; R² represents hydrogen or a hydrocarbyl or substituted hydrocarbyl group having 1 to 8 carbon atoms; Z represents an oxygen or sulphur atom; R³ represents a hydrocarbyl or substituted hydrocarbyl group having 1 to 20 carbon atoms; and R¹ represents a hydrocarbyl or substituted hydrocarbyl group having 1 to 20 carbon atoms other than a group of the formula R³—Z—CH(R²)— as defined above.

The invention also includes a diene elastomer composition comprising a diene elastomer, a hydrolysable silane and a curing agent for the diene elastomer, characterised in that the hydrolysable silane is a hydrolysable silane of the formula G—OC(O)-(Az)-J wherein G and J each represent a hydrocarbyl or substituted hydrocarbyl group having 1 to 40 carbon atoms, at least one of G and J being a group of the formula RₐR″₃₋ₐSi-A in which R represents a hydrolysable group; R″ represents a hydrocarbyl group having 1 to 8 carbon atoms; a has a value in the range 1 to 3 inclusive; Az represents an aziridine ring bonded to the group J through its nitrogen atom; and A represents a divalent organic spacer linkage having at least one carbon atom.

The invention further includes the use of a hydrolysable silane of the formula

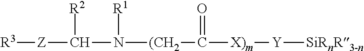

wherein each R represents a hydrolysable group; each R″ represents a hydrocarbyl group having 1 to 8 carbon atoms; n=1 to 3; Y represents a divalent organic spacer linkage having 1 to 20 carbon atoms; X represents —O— or —NH—; m=0 or 1; R² represents hydrogen or a hydrocarbyl or substituted hydrocarbyl group having 1 to 8 carbon atoms; Z represents an oxygen or sulphur atom; R³ represents a hydrocarbyl or substituted hydrocarbyl group having 1 to 20 carbon atoms; and R¹ represents a hydrocarbyl or substituted hydrocarbyl group having 1 to 20 carbon atoms other than a group of the formula R³—Z—CH(R²)— as defined above; as a coupling agent for a diene elastomer composition containing a filler.

The invention also includes the use of a hydrolysable silane of the formula G-OC(O)-(Az)-J wherein G and J each represent a hydrocarbyl or substituted hydrocarbyl group having 1 to 40 carbon atoms, at least one of G and J being a group of the formula RₐR″₃₋ₐSi-A in which R represents a hydrolysable group; R″ represents a hydrocarbyl group having 1 to 8 carbon atoms; a has a value in the range 1 to 3 inclusive; Az represents an aziridine ring bonded to the group J through its nitrogen atom; and A represents a divalent organic spacer linkage having at least one carbon atom; as a coupling agent for a diene elastomer composition containing a filler.

The hydrolysable silanes of the formula

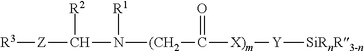

as defined above are capable of bonding strongly to polymeric material having a carbon backbone containing carbon-to-carbon unsaturation. For example these hydrolysable silanes bond strongly to diene elastomers under the processing conditions used for producing elastomer products such as tyres. We believe that upon heating to the temperatures used in elastomer processing, the etheramine or thioetheramine moiety of the above hydrolysable silanes forms a very reactive species which reacts with the C═C bonds, for example those present in diene elastomers, through [2+3] cycloaddition.

Similarly the hydrolysable silanes of the formula G—OC(O)-(Az)-J as defined above are capable of bonding strongly to polymeric material having a carbon backbone containing carbon-to-carbon unsaturation. For example these hydrolysable silanes bond strongly to diene elastomers under the processing conditions used for producing elastomer products such as tyres, reacting through the aziridine ring which reacts with C═C bonds of the elastomer through cycloaddition.

The hydrolysable silanes of the invention are also capable of bonding strongly to fillers having surface hydroxyl groups through hydrolysis of the silane group, thus forming very effective coupling agents.

For hydrolysable silanes of the formula

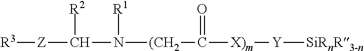

as defined above and hydrolysable silanes of the formula G-OC(O)-(Az)-J as defined above, hydrolysable silanes in which n=3 or a=3 may be preferred as having the maximum number of hydrolysable groups. Examples of groups of the formula: RₙR′₃₋ₙSi—Y— or RₐR′₃₋ₐSi-A- in which n=3 or a=3 include trialkoxysilylalkyl groups such as triethoxysilylalkyl or trimethoxysilylalkyl groups, or triacetoxysilylalkyl groups. However hydrolysable silanes in which n or a=2 or n or a=1 are also useful coupling agents. In such hydrolysable silanes the group R′ is a hydrocarbyl group having 1 to 8 carbon atoms. Preferred groups R′ include alkyl groups having 1 to 4 carbon atoms such as methyl or ethyl, but R′ can be an alkyl group having more carbon atoms such as hexyl or 2-ethylhexyl or can be an aryl group such as phenyl. Examples of groups of the formula RₙR′₃₋ₙSi—Y— or RₐR′₃₋ₐSi-A- in which n or a=2 include diethoxymethylsilylalkyl, diethoxyethylsilylalkyl, dimethoxymethylsilylalkyl or diacetoxymethylsilylalkyl groups.

Hydrolysable silanes in which the group R is an ethoxy group are often preferred. The alcohol or acid RH may be released when the silane is hydrolysed, and ethanol is the most environmentally friendly compound among the alcohols and acids.

In the group of the formula RₙR′₃₋ₙSi—Y—, Y represents a divalent organic spacer linkage having 1 to 20 carbon atoms. Y can conveniently be an alkylene group, particularly an alkylene group having 2 to 6 carbon atoms. Similarly in the group of the formula RₐR′₃₋ₐSi-A-, A represents a divalent organic spacer linkage having 1 to 20 carbon atoms, preferably an alkylene group having 2 to 6 carbon atoms. Preferred examples of linkage Y or A are —(CH₂)₃—, —(CH₂)₄—, and —CH₂CH(CH₃)CH₂— groups. The group of the formula RₙR′₃₋ₙSi—Y— or RₐR′₃₋ₐSi-A- can for example be a 3-(triethoxysilyl)propyl, 4-(triethoxysilyl)butyl, 2-methyl-3-(triethoxysilyl)propyl, 3-(trimethoxysilyl)propyl, 3-triacetoxysilylpropyl, 3-(diethoxymethylsilyl)propyl, 3-(diethoxyethylsilyl)propyl or 3-(diacetoxymethylsilyl)propyl group.

The hydrolysable silanes of the formula

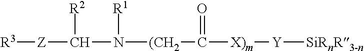

can be prepared by the reaction of a secondary aminoalkylsilane of the formula R¹—NH—(CH₂—C(O)—X)ₘ—Y—SiRₙR″₃₋ₙ wherein each R represents a hydrolysable group; each R″ represents a hydrocarbyl group having 1 to 8 carbon atoms; n=1 to 3; Y represents a divalent organic spacer linkage having 1 to 20 carbon atoms; X represents —O— or —NH—; m=0 or 1; and R¹ represents a hydrocarbyl or substituted hydrocarbyl group having 1 to 20 carbon atoms; with an aldehyde of the formula R²—CHO wherein R² represents hydrogen or a hydrocarbyl or substituted hydrocarbyl group having 1 to 8 carbon atoms and an alcohol or thiol of the formula R³ZH wherein Z represents an oxygen or sulphur atom; and R³ represents a hydrocarbyl or substituted hydrocarbyl group having 1 to 20 carbon atoms.

In the secondary aminoalkylsilane which is reacted with an aldehyde and an alcohol or thiol, the group R¹ can for example represent a hydrocarbyl group having 1 to 8 carbon atoms. For example the group R¹ can be an alkyl group such as H(CH₂)₁₋₈, for example a methyl or ethyl group. The group R¹ can alternatively be an aryl or aralkyl group, for example a phenyl group or a benzyl group. When m=0, the secondary aminoalkylsilane can for example be CH₃—NH—(CH₂)₃—Si(OC₂H₅)₃. Alternatively when m=1, the secondary aminoalkylsilane can for example be CH3-NH—CH₂—C(O)O—(CH₂)₃—Si(OC₂H₅)₃.

The aldehyde which is reacted with a secondary aminoalkylsilane and an alcohol or thiol has the formula R²—CHO wherein R² represents hydrogen or a hydrocarbyl or substituted hydrocarbyl group having 1 to 8 carbon atoms. A preferred aldehyde is formaldehyde, wherein R² represents hydrogen. The formaldehyde can for example be added to the reaction in the form of paraformaldehyde. Alternative aldehydes include acetaldehyde and butyraldehyde.

In one preferred set of hydrolysable silanes of the formula

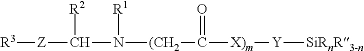

Z represents an oxygen atom and R³ represents a hydrocarbyl group having 1 to 8 carbon atoms. Such silanes can be formed by reaction of an alcohol of the formula R³OH with a secondary aminoalkylsilane and an aldehyde. Examples of suitable alcohols include ethanol, methanol, propanol, n-butanol, 2-methylpropanol, t-butanol, n-hexanol and 2-ethylhexanol. The alcohol can act as both solvent and reagent in the reaction with the secondary aminoalkylsilane and aldehyde.

The most preferred alcohol is ethanol, i.e. R³ is preferably ethyl. When the hydrolysable silane of the invention reacts with the C═C bonds present in diene elastomers through [2+3] cycloaddition, an alcohol of the formula R³OH may be liberated. Ethanol is preferred as the most environmentally friendly alcohol.

Examples of this type of hydrolysable silane include

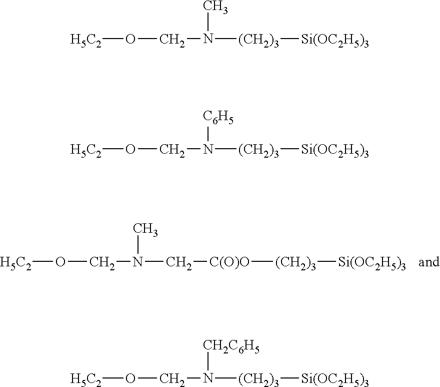

all formed by the reaction of the appropriate secondary aminoalkylsilane with paraformaldehyde in the presence of ethanol as solvent and reagent.

The group R¹ in the hydrolysable silanes of the formula

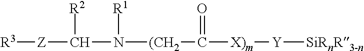

can alternatively represent a group of the formula —Y*—SiR_{q}R″_{3-q} wherein Y* represents a divalent organic spacer linkage having 1 to 20 carbon atoms; each R represents a hydrolysable group; each R″ represents a hydrocarbyl group having 1 to 8 carbon atoms; and q=1 to 3. The linkage Y* can be the same as or different to Y, and q can be the same as or different from n. Usually the group —Y*—SiR_{q}R″_{3-q} is the same as the group —Y—SiRₙR″₃₋ₙ, that is the secondary aminoalkylsilane which is reacted with an aldehyde and an alcohol or thiol has the formula HN(—Y—SiRₙR″₃₋ₙ)₂. The secondary aminoalkylsilane can for example be HN(—(CH₂)₃—Si(OC₂H₅)₃)₂. The hydrolysable silane formed from such a secondary aminoalkylsilane with formaldehyde and an alcohol has the formula R³—O—CH₂—N(—Y—SiRₙR″₃₋ₙ)₂. Such a hydrolysable silane has the advantage of a large number of hydrolysable groups R for bonding to a filler such as silica. The hydrolysable silane of the invention can for example be

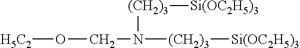

The secondary aminoalkylsilane can alternatively be a bis(secondary aminoalkylsilane) for example of the formula RₙR″₃₋ₙSi—Y—(X—C(O)—CH2)m-NH—(CH₂)_{d}—NH—(CH₂—C(O)—X″)ₘ—Y**—SiRᵣR″₃₋ᵣ where R, R″, n, Y, X and m are defined as above and d=1 to 8; R⁸ represents hydrogen or a hydrocarbyl or substituted hydrocarbyl group having 1 to 8 carbon atoms; Z represents an oxygen or sulphur atom; R⁹ represents a hydrocarbyl or substituted hydrocarbyl group having 1 to 20 carbon atoms; X″ represents —O— or —NH—; m″=0 or 1; Y** represents a divalent organic spacer linkage having 1 to 20 carbon atoms; each R represents a hydrolysable group; each R″ represents a hydrocarbyl group having 1 to 8 carbon atoms; and r=1 to 3. Reaction of such a secondary aminoalkylsilane with an aldehyde of the formula R²—CHO and an alcohol of the formula R³OH forms a hydrolysable silane of the invention having the formula

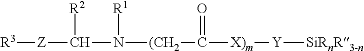

in which R¹ represents a group of the formula

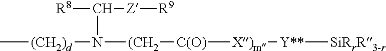

The secondary aminoalkylsilane can for example be of the formula (C₂H₅O)₃Si—(CH₂)₃—NH—(CH₂)_{d}—NH—(CH₂)₃—Si(OC₂H₅)₃ forming a hydrolysable silane of the invention having the formula

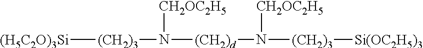

by reaction with formaldehyde and ethanol.

The group R¹ in the hydrolysable silanes of the formula

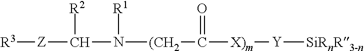

can alternatively be a carboxyalkyl ester group of the formula —(CH₂)ₑ—C(O)OR¹⁰ wherein e=1 to 8; and R¹⁰ represents a hydrocarbyl group having 1 to 8 carbon atoms, for example an ethyl carboxymethyl group or a methyl 3-carboxypropyl group. The secondary aminoalkylsilane can for example be of the formula C₂H₅—C(O)O—CH₂—NH—(CH₂)₃—Si(OC₂H₅)₃ forming a hydrolysable silane of the invention having the formula

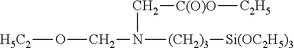

by reaction with formaldehyde and ethanol.

The alcohol of the formula R³OH which is reacted with a secondary aminoalkylsilane and an aldehyde can alternatively be of the formula HO—((CH2)ₐO)_{b}—R⁴ wherein a=1 to 3; b=1 to 6; and R⁴ represents hydrogen or a hydrocarbyl or substituted hydrocarbyl group having 1 to 20 carbon atoms. In this case the alcohol R³OH is a diol such as ethylene glycol or propylene glycol, a polyoxyalkylene glycol such as polyoxyethylene glycol or polyoxypropylene glycol, an etheralcohol such as ethoxyethanol or methoxyethanol or a polyoxyalkylene glycol monoether such as ethoxyethoxyethanol.

When the alcohol R³OH is an etheralcohol or a polyoxyalkylene glycol monoether, reaction with a secondary aminoalkylsilane of the formula R¹—NH—(CH₂—C—X)ₘ—Y—SiRₙR″₃₋ₙ and an aldehyde of the formula R²—CHO forms a hydrolysable silane of the formula

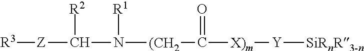

wherein R³ represents an alkoxyalkyl group or poly(alkoxy)alkyl group. An example of such a hydrolysable silane is

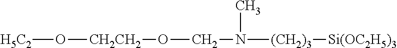

formed by reaction of ethoxyethanol with N-methyl-3-(triethoxysilyl)propylamine and formaldehyde.

When the alcohol R³OH is a diol or a polyoxyalkylene glycol, reaction with a secondary aminoalkylsilane and an aldehyde can also form a bis(silylalkylaminoalkyl)ether by reaction of both alcohol groups of the diol or polyoxyalkylene glycol, if the diol or polyoxyalkylene glycol is used in stoichiometric excess. Reaction of a diol or polyoxyalkylene glycol of the formula HO—((CH2)ₐO)_{b}—R⁴, wherein a=1 to 3; b=1 to 6; and R⁴ represents hydrogen, with a secondary aminoalkylsilane of the formula R¹—N—(CH₂—C—X)ₘ—Y—SiRₙR″₃₋ₙ and an aldehyde of the formula R²—CHO can form a bis(silylalkylaminoalkyl)ether of the formula

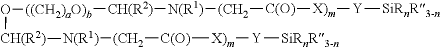

An example of such a bis(silylalkylaminoalkyl)ether is

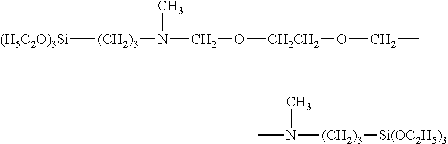

formed by the reaction of ethylene glycol with N-methyl-3-(triethoxysilyl)propylamine and formaldehyde. The reaction product of the diol or polyoxyalkylene glycol with the secondary aminoalkylsilane of the formula R¹—N—(CH₂—C—X)ₘ—Y—SiRₙR″₃₋ₙ and the aldehyde of the formula R²—CHO may be a mixture of a bis(silylalkylaminoalkyl)ether of the formula —O—(CH2)ₐO)_{b}—CH(R²)—N(R¹)—(CH₂—C—X)ₘ—Y—SiRₙR″₃₋ₙ—CH(R²)—N(R¹)—(CH₂—C—X)ₘ—Y—SiRₙR″₃₋ₙ and a hydrolysable silane of the formula

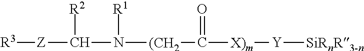

wherein R³ represents a hydroxyalkyl group or poly(alkoxy)alkyl group of the formula —((CH2)ₐO)_{b}—H.

When Z is sulphur in the hydrolysable silanes of the formula

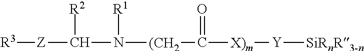

that is when the reagent R³ZH is a thiol, the thiol is preferably not a simple alkylthiol since a malodorous alkylthiol may then be liberated during reaction with the C═C bonds present in diene elastomers upon heating to the temperatures used in elastomer processing. The group R³ in a thiol R³SH preferably contains an anchoring group whereby any thiol liberated will remain chemically bound in the elastomer composition. Most preferably the group R³ contains a hydrolysable silane group, since hydrolysable silane groups are capable of bonding strongly to fillers through hydrolysis of the silane group. R³ can for example be a group of the formula —Y″—SiRₚR″₃₋ₚ wherein Y″ represents a divalent organic spacer linkage having 1 to 20 carbon atoms; each R represents a hydrolysable group; each R″ represents a hydrocarbyl group having 1 to 8 carbon atoms; and p=1 to 3. The thiol can for example be

### HS—(CH₂)₃—Si(OC₂H₅)₃.

The thiol of the formula HS—Y″—SiRₚR″₃₋ₚ can be reacted with a secondary aminoalkylsilane of the formula R¹—NH—(CH₂—C—X)ₘ—Y—SiRₙR″₃₋ₙ and an aldehyde of the formula R²—CHO to form a hydrolysable silane of the formula

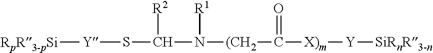

Examples of such hydrolysable silanes include

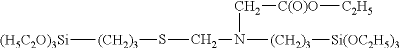

formed by the reaction of HS—(CH₂)₃—Si(OC₂H₅)₃ with C₂H₅—C(O)O—CH₂—NH—(CH₂)₃—Si(OC₂H₅)₃ and formaldehyde;

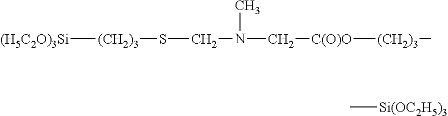

formed by the reaction of HS—(CH₂)₃—Si(OC₂H₅)₃ with CH₃—NH—CH₂—C(O)O—(CH₂)₃—Si(OC₂H₅)₃ and formaldehyde;

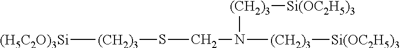

formed by the reaction of HS—(CH₂)₃—Si(OC₂H₅)₃ with HN(—(CH₂)₃—Si(OC₂H₅)₃)₂ and formaldehyde; and

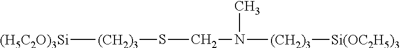

formed by the reaction of HS—(CH₂)₃—Si(OC₂H₅)₃ with CH₃—NH—(CH₂)₃—Si(OC₂H₅)₃ and formaldehyde.

In the hydrolysable silanes of the formula G-OC(O)-(Az)-J in which G is a group of the formula RₐR′₃₋ₐSi-A-, J can be any hydrocarbyl or substituted hydrocarbyl group having 1 to 40 carbon atoms. J can for example be an alkyl group having 1 to 6 carbon atoms such as methyl, ethyl, butyl or hexyl, or can be a longer chain alkyl group, or can be an aryl group having 6 to 10 carbon atoms such as phenyl or tolyl or an aralkyl group such as benzyl or 2-phenylpropyl. J can alternatively be a substituted hydrocarbyl group such as a hydroxyalkyl, aminoalkyl, or alkoxyalkyl group or a group of the formula RₐR′₃₋ₐSi-A-.

In the hydrolysable silanes of the formula G-OC(O)-(Az)-J in which J is a group of the formula RₐR′₃₋ₐSi-A-, G can in general be any hydrocarbyl or substituted hydrocarbyl group having 1 to 40 carbon atoms. Y can for example be an alkyl group having 1 to 10 or more carbon atoms, an aryl group having 6 to 10 carbon atoms, an aralkyl group or a substituted hydrocarbyl group.

Hydrolysable silanes of the formula G-OC(O)-(Az)-J in which both G and J are substituted hydrocarbyl groups of the formula RₐR′₃₋ₐSi-A- are one type of preferred examples of hydrolysable silanes for use in the invention. Examples of such hydrolysable silanes include

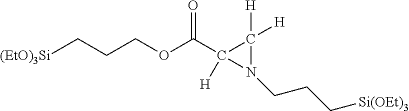

where Et represents ethyl and similar silanes in which one or both of the 3-(triethoxysilyl)propyl groups is replaced by a different RₐR′₃₋ₐSi-A- group selected from those listed above.

The hydrolysable silanes of the formula G-OC(O)-(Az)-J can in general be prepared by reacting an alkyl or substituted alkyl 2,3-dibromopropionate of the formula G—OC(O)—CHBr—CH₂Br with an amine of the formula J-NH₂, wherein G and J each represent a hydrocarbyl or substituted hydrocarbyl group having 1 to 40 carbon atoms, at least one of G and J being a group of the formula RₐR″₃₋ₐSi-A in which R represents a hydrolysable group; R″ represents a hydrocarbyl group having 1 to 8 carbon atoms; a has a value in the range 1 to 3 inclusive; and A represents a divalent organic spacer linkage having at least one carbon atom.

The 2,3-dibromopropionates of the formula G-OC(O)—CHBr—CH₂Br can be prepared from an acrylate of the formula G-OC(O)—CH═CH₂ by reaction with bromine at ambient temperature or below. For example the substituted alkyl 2,3-dibromopropionates of the formula Y—OC(O)—CHBr—CH₂Br in which Y is a group of the formula RₐR′₃₋ₐSi-A-, that is the substituted alkyl 2,3-dibromopropionates of the formula RₐR′₃₋ₐSi-A-OC(O)—CHBr—CH₂Br, where R, R′, a and A are defined as above, can be prepared by the reaction of an acrylate of the formula RₐR′₃₋ₐSi-A-OC(O)—CH═CH₂ with bromine.

The hydrolysable silanes of the formula G-OC(O)-(Az)-J in which J represents a group of the formula RₐR″₃₋ₐSi-A, where R, R′, a and A are defined as above, can be prepared by the reaction of a 2,3-dibromopropionate of the formula G-OC(O)—CHBr—CH₂Br with an amine of the formula RₐR′₃₋ₐSi-A-NH₂. The group G can for example be a substituted hydrocarbyl group which is the residue of a polyol having 2 to 6 alcohol groups. This 2,3-dibromopropionate can be prepared from the corresponding acrylate by reaction with bromine as described above. Examples of polyol acrylates that can be brominated and reacted with an alkoxysilylalkylamine include diacrylates such as ethyleneglycol diacrylate, di- and triethyleneglycol diacrylates and polyethyleneglycol diacrylates of varying chain lengths, propyleneglycol diacrylate, di- and tripropyleneglycol diacrylate and polypropyleneglycol diacrylates of varying chain lengths, butanediol-1,3- and -1,4-diacrylates, neopentylglycol diacrylate, hexanediol-1,6-diacrylate, isosorbide diacrylate, 1,4-cyclohexanedimethanol diacrylate, bisphenol-A-diacrylate and the diacrylates of bisphenol-A, hydroquinone, resorcinol lengthened with ethylene oxide and propylene oxide, triacrylates such as trimethylolpropane triacrylate, glycerol triacrylate, trimethylolethane triacrylate, 2-hydroxymethylbutanediol-1,4-triacrylate, and the triacrylates of glycerol, trimethylolethane or trimethylolpropane lengthened with ethylene oxide- or propylene oxide, and higher polyol acrylates such as pentaerythritol tetraacrylate and di-pentaerythritol hexaacrylate. Thus in a hydrolysable silane hydrolysable silanes of the formula G-OC(O)-(Az)-J in which J represents a group of the formula RₐR″₃₋ₐSi-A, the group G may optionally represent a substituted hydrocarbyl group which is the residue of a polyol having 2 to 6 alcohol groups, the group G being bonded to 1 to 6 groups of the formula —OC(O)-(AZ)-A′-Si—RₐR″₃₋ₐ

The hydrolysable silane of the formula

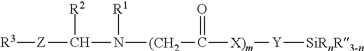

as defined above or of the formula G-OC(O)-(Az)-J as defined above can be partially hydrolysed and condensed into oligomers containing siloxane linkages. It is preferred that such oligomers still contain at least one hydrolysable group bonded to Si per unsaturated silane monomer unit to enhance coupling of the unsaturated silane with fillers having surface hydroxyl groups.

The polymeric material having a carbon backbone containing carbon-to-carbon unsaturation and the hydrolysable silane of the formula

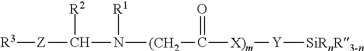

as defined above or of the formula G-OC(O)-(Az)-J as defined above are preferably heated together at a temperature of at least 80° C., more preferably to a temperature between 90° C. and 200° C., most preferably between 120° C. and 180° C. The polymeric material and the hydrolysable silane can be mixed followed by a separate heating step, or mixing and heating can be carried out together.

The preferred polymeric material is a hydrocarbon polymer containing ethylenic unsaturation such as a diene elastomer, but the hydrolysable silanes defined above can also be used to modify other polymeric material having a carbon backbone containing carbon-to-carbon unsaturation such as carbon fibre or carbon black. When the polymeric material is an elastomer, mixing and heating are preferably carried out together so that the elastomer is subjected to mechanical working while it is heated.

In the diene elastomer compositions of the invention, the diene elastomer can be natural rubber. We have found that the hydrolysable silanes of the formula

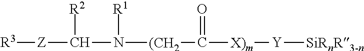

as defined above and the hydrolysable silanes of the formula G-OC(O)-(Az)-J as defined above each react readily with natural rubber under the processing conditions used for producing rubber products such as tyres and also act as an effective coupling agent in a curable filled natural rubber composition.

The diene elastomer can alternatively be a synthetic polymer which is a homopolymer or copolymer of a diene monomer (a monomer bearing two double carbon-carbon bonds, whether conjugated or not). Preferably the elastomer is an “essentially unsaturated” diene elastomer, that is a diene elastomer resulting at least in part from conjugated diene monomers, having a content of members or units of diene origin (conjugated dienes) which is greater than 15 mol %. More preferably it is a “highly unsaturated” diene elastomer having a content of units of diene origin (conjugated dienes) which is greater than 50 mol %. Diene elastomers such as butyl rubbers, copolymers of dienes and elastomers of alpha-olefins of the ethylene-propylene diene monomer (EPDM) type, which may be described as “essentially saturated” diene elastomers having a low (less than 15 mol %) content of units of diene origin are less preferred.

The diene elastomer can for example be:
(a) any homopolymer obtained by polymerization of a conjugated diene monomer having 4 to 12 carbon atoms;
(b) any copolymer obtained by copolymerization of one or more dienes conjugated together or with one or more vinyl aromatic compounds having 8 to 20 carbon atoms;
(c) a ternary copolymer obtained by copolymerization of ethylene, of an α-olefin having 3 to 6 carbon atoms with a non-conjugated diene monomer having 6 to 12 carbon atoms, such as, for example, the elastomers obtained from ethylene, from propylene with a non-conjugated diene monomer of the aforementioned type, such as in particular 1,4-hexadiene, ethylidene norbornene or dicyclopentadiene;
(d) a copolymer of isobutene and isoprene (butyl rubber), and also the halogenated, in particular chlorinated or brominated, versions of this type of copolymer.

Suitable conjugated dienes include 1,3-butadiene, 2-methyl-1,3-butadiene, 2,3-di(Ci-C5 alkyl)-1,3-butadienes such as, for instance, 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene and 2,4-hexadiene.

Suitable vinyl aromatic compounds are, for example, styrene, ortho-, meta- and para-methylstyrene, the commercial mixture “vinyltoluene”, para-tert.-butylstyrene, methoxystyrenes, chlorostyrenes, vinylmesitylene, divinylbenzene and vinylnaphthalene. The copolymers may contain between 99% and 20% by weight of diene units and between 1% and 80% by weight of vinyl aromatic units. The elastomers may have any microstructure, which is a function of the polymerization conditions used, in particular of the presence or absence of a modifying and/or randomizing agent and the quantities of modifying and/or randomizing agent used. The elastomers may for example be block, statistical, sequential or microsequential elastomers, and may be prepared in dispersion or in solution; they may be coupled and/or starred or alternatively functionalized with a coupling and/or starring or functionalizing agent. Examples of preferred block copolymers are styrene-butadiene-styrene (SBS) block copolymers and styrene-ethylene/butadiene-styrene (SEBS) block copolymers.

The elastomer can be an alkoxysilane-terminated diene polymer or a copolymer of the diene and an alkoxy-containing molecule prepared via a tin coupled solution polymerization.

When preparing a filled elastomer composition, the elastomer and the hydrolysable silane can be reacted and then mixed with the filler, but the filler is preferably present during the reaction between the elastomer and the unsaturated silane. The elastomer, the silane, the filler and the radical initiator can all be loaded to the same mixer and mixed while being heated, for example by thermo-mechanical kneading. Alternatively the filler can be pre-treated with the hydrolysable silane and then mixed with the elastomer and the radical initiator, preferably under heating. When the hydrolysable silane and radical generator are present during thermo-mechanical kneading of the diene elastomer and the filler, the silane reacts with the elastomer to form a modified diene elastomer and also acts as a coupling agent bonding the filler to the elastomer.

The filler is preferably a reinforcing filler. Examples of reinforcing fillers are silica, silicic acid, carbon black, or a mineral oxide of aluminous type such as alumina trihydrate or an aluminium oxide-hydroxide, or a silicate such as an aluminosilicate, or a mixture of these different fillers.

Use of an unsaturated silane of the formula

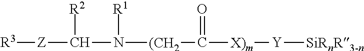

as defined above or of the formula G-OC(O)-(Az)-J as defined above is particularly advantageous in a curable elastomer composition comprising a filler containing hydroxyl groups, particularly in reducing the mixing energy required for processing the rubber composition and improving the performance properties of products formed by curing the rubber composition. The hydroxyl-containing filler can for example be a mineral filler, particularly a reinforcing filler such as a silica or silicic acid filler, as used in white tire compositions, or a metal oxide such as a mineral oxide of aluminous type such as alumina trihydrate or an aluminium oxide-hydroxide, or carbon black pre-treated with a alkoxysilane such as tetraethyl orthosilicate, or a silicate such as an aluminosilicate or clay, or cellulose or starch, or a mixture of these different fillers.

The reinforcing filler can for example be any commonly employed siliceous filler used in rubber compounding applications, including pyrogenic or precipitated siliceous pigments or aluminosilicates. Precipitated silicas are preferred, for example those obtained by the acidification of a soluble silicate, e.g., sodium silicate. The precipitated silica preferably has a BET surface area, as measured using nitrogen gas, in the range of about 20 to 600 m²/g, and more usually in a range of about 40 or 50 to about 300 m²/g. The BET method of measuring surface area is described in the Journal of the American Chemical Society, Volume 60, Page 304 (1930). The silica may also be typically characterized by having a dibutylphthalate (DBP) value in a range of about 100 to about 350 cm³/100 g, and more usually about 150 to about 300 cm³/100 g, measured as described in ASTM D2414. The silica, and the alumina or aluminosilicate if used, preferably have a CTAB surface area in a range of about 100 to about 220 m²/g (ASTM D3849). The CTAB surface area is the external surface area as evaluated by cetyl trimethylammonium bromide with a pH of 9. The method is described in ASTM D 3849.

Various commercially available silicas may be considered for use in elastomer compositions according to this invention such as silicas commercially available from Rhodia with, for example, designations of Zeosil® 1165MP, 11 15MP, or HRS 1200MP; 200MP premium, 80GR or equivalent silicas available from PPG Industries with designations Hi-Sil® EZ150G, 210, 243, etc; silicas available from Degussa AG with, for example, designations VN3, Ultrasil® 7000 and Ultrasil 7005, and silicas commercially available from Huber having, for example, a designation of Hubersil® 8745 and Hubersil 8715. Treated precipitated silicas can be used, for example the aluminium-doped silicas described in EP-A-735088.

If alumina is used in the elastomer compositions of the invention, it can for example be natural aluminium oxide or synthetic aluminium oxide (Al2O3) prepared by controlled precipitation of aluminium hydroxide. The reinforcing alumina preferably has a BET surface area from 30 to 400 m²/g, more preferably between 60 and 250 m²/g, and an average particle size at most equal to 500 nm, more preferably at most equal to 200 nm. Examples of such reinforcing aluminas are the aluminas A125, CR125, D65CR from Baiotakowski.

Examples of aluminosilicates which can be used in the elastomer compositions of the invention are Sepiolite, a natural aluminosilicate which might be obtained as PANSIL® from Tolsa S.A., Toledo, Spain, and SILTEG®, a synthetic aluminosilicate from Degussa GmbH.

The hydroxyl-containing filler can alternatively be talc, magnesium dihydroxide or calcium carbonate, or a natural organic filler such as cellulose fibre or starch. Mixtures of mineral and organic fillers can be used, as can mixtures of reinforcing and non-reinforcing fillers.

The filler can additionally or alternatively comprise a filler which does not have hydroxyl groups at its surface, for example a reinforcing filler such as carbon black and/or a non-reinforcing filler such as calcium carbonate.

The hydrolysable silane is preferably present in the diene elastomer composition at least 0.2% by weight based on the diene elastomer and can be up to 20% or more. Preferably the hydrolysable silane is present at 0.5 to 15.0% by weight based on the diene elastomer during thermal processing of the elastomer composition, most preferably 0.5 to 10.0%.

Curing of the diene elastomer composition of the invention can be carried out as a batch process or as a continuous process using any suitable apparatus.

Continuous processing can be effected in an extruder such as a single screw or twin screw extruder. The extruder is preferably adapted to mechanically work, that is to knead or compound, the materials passing through it, for example a twin screw extruder. One example of a suitable extruder is that sold under the trade mark ZSK from Coperion Werner Pfleiderer. The extruder preferably includes a vacuum port shortly before the extrusion die to remove any unreacted silane. The residence time of the diene elastomer, the unsaturated silane and the free radical initiator at above 100° C. in the extruder or other continuous reactor is generally at least 0.5 minutes and preferably at least 1 minute and can be up to 15 minutes. More preferably the residence time is 1 to 5 minutes.

A batch process can for example be carried out in an internal mixer such as a Banbury mixer or a Brabender Plastograph (Trade Mark) 350S mixer equipped with roller blades. An external mixer such as a roll mill can be used for either batch or continuous processing. In a batch process, the elastomer, the hydrolysable silane and the free radical initiator are generally mixed together at a temperature above 100° C. for at least 1 minute and can be mixed for up to 20 minutes, although the time of mixing at high temperature is generally 2 to 10 minutes.

The elastomer compositions are preferably produced using the conventional two successive preparation phases of mechanical or thermo-mechanical mixing or kneading (“non-productive” phase) at high temperature, followed by a second phase of mechanical mixing (“productive” phase) at lower temperature, typically less than 110° C., for example between 40° C. and 100° C., during which the cross-linking and vulcanization systems are incorporated.

During the non-productive phase, the hydrolysable silane, the diene elastomer, the filler and the radical generator are mixed together. Mechanical or thermo-mechanical kneading occurs, in one or more steps, until a maximum temperature of 110° C. to 190° C. is reached, preferably between 130° C. and 180° C. When the apparent density of the reinforcing inorganic filler is low (generally the case for silica), it may be advantageous to divide the introduction thereof into two or more parts in order to improve further the dispersion of the filler in the rubber. The total duration of the mixing in this non-productive phase is preferably between 2 and 10 minutes.

After cooling of the mixture thus obtained, the curing system is then incorporated at low temperature, typically on an external mixer such as an open mill, or alternatively on an internal mixer (Banbury type). The entire mixture is then mixed (productive phase) for several minutes, for example between 2 and 10 minutes.

The curing agent for the elastomer composition can for example be a conventional sulfur vulcanizing agent. Examples of suitable sulfur vulcanizing agents include, for example, elemental sulfur (free sulfur) or sulfur donating vulcanizing agents, for example, an amine disulfide, polymeric polysulfide or sulfur olefin adducts which are conventionally added in the final, productive, rubber composition mixing step. Preferably, in most cases, the sulfur vulcanizing agent is elemental sulfur. Sulfur vulcanizing agents are used in an amount ranging from about 0.4 to about 8% by weight based on elastomer, preferably 1.5 to about 3%, particularly 2 to 2.5%.

Accelerators are generally used to control the time and/or temperature required for vulcanization and to improve the properties of the vulcanized elastomer composition. In one embodiment, a single accelerator system may be used, i.e., primary accelerator. Conventionally and preferably, a primary accelerator(s) is used in total amounts ranging from about 0.5 to about 4% by weight based on elastomer, preferably about 0.8 to about 1.5%. In another embodiment, combinations of a primary and a secondary accelerator might be used with the secondary accelerator being used in smaller amounts of about 0.05 to about 3% in order to activate and to improve the properties of the vulcanisate. Delayed action accelerators may be used which are not affected by normal processing temperatures but produce a satisfactory cure at ordinary vulcanization temperatures. Suitable types of accelerators that may be used in the present invention are amines, disulfides, guanidines, thioureas, thiazoles, for example mercaptobenzothiazole, thiurams, sulfenamides, dithiocarbamates, thiocarbonates, and xanthates. Preferably, the primary accelerator is a sulfenamide. If a second accelerator is used, the secondary accelerator is preferably a guanidine, dithiocarbamate or thiuram compound. Vulcanization retarders can also be used, for example phthalic anhydride, benzoic acid or cyclohexylthiophthalimide.

The curable diene elastomer composition can contain another coupling agent in addition to the hydrolysable silane of the formula

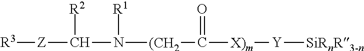

as defined above or of the formula G-OC(O)-(Az)-J as defined above, for example a trialkoxy, dialkoxy or monoalkoxy silane coupling agent, particularly a sulfidosilane or mercaptosilane or an azosilane, acrylamidosilane, blocked mercaptosilane, aminosilane alkylsilane or alkenylsilane having 1 to 20 carbon atoms in the alkyl group and 1 to 6 carbon atoms in the alkoxy group. Examples of preferred coupling agents include a bis(trialkoxysilylpropyl)disulfane or tetrasulfane as described in U.S. Pat. No. 5,684,171, or a bis(dialkoxymethylsilylpropyl)disulfane or tetrasulfane such as bis(methyldiethoxysilylpropyl)tetrasulfane or disulfane, or a bis(dimethylethoxysilylpropyl)oligosulfane, or a dimethylhydroxysilylpropyl dimethylalkoxysilylpropyl oligosulfane as described in WO-A-2007/061550, or a mercaptosilane such as triethoxysilylpropylmercaptosilane. Such a coupling agent promotes bonding of the filler to the organic elastomer, thus enhancing the physical properties of the filled elastomer. The filler can be pre-treated with the coupling agent or the coupling agent can be added to the mixer with the elastomer and filler and the unsaturated silane according to the invention. We have found that use of a hydrolysable silane according to this invention in conjunction with such a coupling agent can reduce the mixing energy required for processing the elastomer composition and improve the performance properties of products formed by curing the elastomer composition compared to compositions containing the coupling agent without the hydrolysable silane of the formula

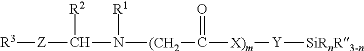

as defined above or of the formula G-OC(O)-(Az)-J as defined above.

The elastomer composition can be compounded with various commonly-used additive materials such as processing additives, for example oils, resins including tackifying resins, silicas, and plasticizers, fillers, pigments, fatty acid, zinc oxide, waxes, antioxidants and antiozonants, heat stabilizers, UV stabilizers, dyes, pigments, extenders and peptizing agents.

Typical amounts of tackifier resins, if used, comprise about 0.5 to about 10% by weight based on elastomer, preferably 1 to 5%. Typical amounts of processing aids comprise about 1 to about 50% by weight based on elastomer. Such processing aids can include, for example, aromatic, naphthenic, and/or paraffinic processing oils.

Typical amounts of antioxidants comprise about 1 to about 5% by weight based on elastomer. Representative antioxidants may be, for example, N-1,3-dimethylbutyl-N-phenyl-para-phenylenediamine, sold as “Santoflex 6-PPD”® from Flexsys, diphenyl-p-phenylenediamine and others, for example those disclosed in The Vanderbilt Rubber Handbook (1978), Pages 344 through 346. Typical amounts of antiozonants also comprise about 1 to 5% by weight based on elastomer.

Typical amounts of fatty acids, if used, which can include stearic acid or zinc stearate, comprise about 0.1 to about 3% by weight based on elastomer. Typical amounts of zinc oxide comprise about 0 to about 5% by weight based on elastomer alternatively 0.1 to 5%.

Typical amounts of waxes comprise about 1 to about 5% by weight based on elastomer. Microcrystalline and/or crystalline waxes can be used.

Typical amounts of peptizers comprise about 0.1 to about 1% by weight based on elastomer. Typical peptizers may for example be pentachlorothiophenol or dibenzamidodiphenyl disulfide.

The diene elastomer composition of the invention containing a curing agent is shaped and cured into an article. The elastomer composition can be used to produce tyres, including any part thereof such as the bead, apex, sidewall, inner liner, tread or carcass. The elastomer composition can alternatively be used to produce any other engineered rubber goods, for example bridge suspension elements, hoses, belts, shoe soles, anti seismic vibrators, and dampening elements. The elastomer composition can be cured in contact with reinforcing elements such as cords, for example organic polymer cords such as polyester, nylon, rayon, or cellulose cords, or steel cords, or fabric layers or metallic or organic sheets.

When a sulphur curing system is used the vulcanization, or curing, of a rubber product such as a tire or tire tread is carried out in known manner at temperatures preferably between 130° C. and 200° C., under pressure, for a sufficiently long period of time. The required time for vulcanization may vary for example between 5 and 90 minutes.

The elastomer composition of the invention is particularly advantageous for use in producing a tyre for a heavy vehicle such as a truck. Preferred elastomers for this use are isoprene elastomers; that is an isoprene homopolymer or copolymer, in other words a diene elastomer selected from the group consisting of natural rubber (NR), synthetic polyisoprenes (IR), the various isoprene copolymers or a mixture of these elastomers. Isoprene copolymers include isobutene-isoprene copolymers (butyl rubber-IIR), isoprene-styrene copolymers (SIR), isoprene-butadiene copolymers (BIR) and isoprene-butadiene-styrene copolymers (SBIR). The isoprene elastomer is most preferably natural rubber or a synthetic cis-1,4 polyisoprene; of these synthetic polyisoprenes, preferably polyisoprenes having a content (mole %) of cis-1,4 bonds greater than 90%, more preferably still greater than 98%, are used. For such a tyre for a heavy vehicle, the elastomer may also be constituted, in its entirety or in part, of another highly unsaturated elastomer such as, for example, an SBR or a BR elastomer. The hydrolysable silane of the invention disperses silica into Natural Rubber to form an elastomer composition for truck tyres whereby tyres made from the composition have reduced rolling resistance with maintained wear compared to known tyres containing carbon black as reinforcing filler.

The elastomer composition of the invention can alternatively be used for a passenger car tire, in which case the preferred starting diene elastomer is for example a styrene butadiene rubber (SBR), for example an SBR prepared in emulsion (“ESBR”) or an SBR prepared in solution (“SSBR”), or an SBR/BR, SBR/NR (or SBR/IR), alternatively BR/NR (or BR/IR), or SIBR (isoprene-butadiene-styrene copolymers), IBR (isoprene-butadiene copolymers), or blends (mixtures) thereof.

When the elastomer composition is for use as a tire sidewall, the elastomer may comprise at least one essentially saturated diene elastomer, in particular at least one EPDM copolymer, which may for example be used alone or in a mixture with one or more of the highly unsaturated diene elastomers.

The modified elastomer composition containing a vulcanizing system can for example be calendered, for example in the form of thin slabs (thickness of 2 to 3 mm) or thin sheets of rubber in order to measure its physical or mechanical properties, in particular for laboratory characterization, or alternatively can be extruded to form rubber profiled elements used directly, after cutting or assembling to the desired dimensions, as a semi-finished product for tires, in particular as treads, plies of carcass reinforcements, sidewalls, plies of radial carcass reinforcements, beads or chaffers, inner tubes or air light internal rubbers for tubeless tires.

The invention provides a process for modifying a polymeric material having a carbon backbone containing carbon-to-carbon unsaturation by reaction with a hydrolysable silane, characterised in that the hydrolysable silane is a silane of the formula

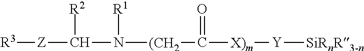

wherein each R represents a hydrolysable group; each R″ represents a hydrocarbyl group having 1 to 8 carbon atoms; n=1 to 3; Y represents a divalent organic spacer linkage having 1 to 20 carbon atoms; X represents —O— or —NH—; m=0 or 1; R² represents hydrogen or a hydrocarbyl or substituted hydrocarbyl group having 1 to 8 carbon atoms; Z represents an oxygen or sulphur atom; R³ represents a hydrocarbyl or substituted hydrocarbyl group having 1 to 20 carbon atoms; and R¹ represents a hydrocarbyl or substituted hydrocarbyl group having 1 to 20 carbon atoms or a silane of formula (2) G-OC(O)-(Az)-J wherein G and J each represent a hydrocarbyl or substituted hydrocarbyl group having 1 to 40 carbon atoms, at least one of G and J being a group of the formula RaR″3-aSi-A in which R represents a hydrolysable group; R″ represents a hydrocarbyl group having 1 to 8 carbon atoms; a has a value in the range 1 to 3 inclusive; Az represents an aziridine ring bonded to the group J through its nitrogen atom; and A represents a divalent organic spacer linkage having at least one carbon atom or a mixture thereof.

Preferably, R¹ represents a group other than a group of the formula R³—Z—CH(R²)— as defined above.

The invention extends to a process characterised in that Z represents an oxygen atom and R3 represents a hydrocarbyl group having 1 to 8 carbon atoms.

The invention provides a process characterised in that Z represents an oxygen atom and R3 represents a group of the formula —((CH2)aO)b-R4 wherein a=1 to 3; b=1 to 6; and R4 represents hydrogen or a hydrocarbyl or substituted hydrocarbyl group having 1 to 20 carbon atoms.

The invention provides a process characterised in that Z represents a sulphur atom and R3 represents a group of the formula —Y″—SiRpR″3-p wherein Y″ represents a divalent organic spacer linkage having 1 to 20 carbon atoms; each R represents a hydrolysable group; each R″ represents a hydrocarbyl group having 1 to 8 carbon atoms; and p=1 to 3.

The invention provides a process characterised in that R1 represents a hydrocarbyl group having 1 to 8 carbon atoms.

The invention provides a process characterised in that R1 represents a group of the formula —Y*—SiRqR″3-q wherein Y* represents a divalent organic spacer linkage having 1 to 20 carbon atoms; each R represents a hydrolysable group; each R″ represents a hydrocarbyl group having 1 to 8 carbon atoms; and q=1 to 3.

The invention provides a process characterised in that R1 represents a group of the formula

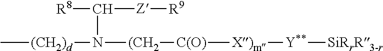

wherein d=1 to 8; R⁸ represents hydrogen or a hydrocarbyl or substituted hydrocarbyl group having 1 to 8 carbon atoms; Z represents an oxygen or sulphur atom; R⁹ represents a hydrocarbyl or substituted hydrocarbyl group having 1 to 20 carbon atoms; X″ represents —O— or —NH—; m″=0 or 1; Y** represents a divalent organic spacer linkage having 1 to 20 carbon atoms; each R represents a hydrolysable group; each R″ represents a hydrocarbyl group having 1 to 8 carbon atoms; and r=1 to 3.

The invention provides a process characterised in that R1 represents a group of the formula —(CH2)e-C(O)OR10 wherein e=1 to 8; and R10 represents a hydrocarbyl group having 1 to 8 carbon atoms.

The invention provides a process characterised in that R2 represents hydrogen.

The invention provides a process for modifying a polymeric material having a carbon backbone containing carbon-to-carbon unsaturation by reaction with a hydrolysable silane, characterised in that the hydrolysable silane is a silane of the formula G—OC(O)-(Az)-J wherein G and J each represent a hydrocarbyl or substituted hydrocarbyl group having 1 to 40 carbon atoms, at least one of G and J being a group of the formula RaR″3-aSi-A in which R represents a hydrolysable group; R″ represents a hydrocarbyl group having 1 to 8 carbon atoms; a has a value in the range 1 to 3 inclusive; Az represents an aziridine ring bonded to the group J through its nitrogen atom; and A represents a divalent organic spacer linkage having at least one carbon atom.

The invention provides a process characterised in that the hydrolysable silane has the formula RaR″3-aSi-A-OC(O)-(Az)-J wherein R, R″, A, a and Az are defined as in Claim 1 and J represents a hydrocarbyl or substituted hydrocarbyl group having 1 to 40 carbon atoms.

The invention provides a process characterised in that the hydrolysable silane has the formula G-OC(O)-(Az)-A-Si—RaR″3-a wherein R, R″, A, a and Az are defined as in Claim 1 and G represents a hydrocarbyl or substituted hydrocarbyl group having 1 to 40 carbon atoms.

The invention provides a process characterised in that the group G of the hydrolysable silane represents a substituted hydrocarbyl group which is the residue of a polyol having 2 to 6 alcohol groups, the group G being bonded to 1 to 6 groups of the formula —OC(O)-(Az)-A′-Si—RaR″3-a wherein R, R″, A, a and Az are defined as in Claim 1.

The invention provides a process characterised in that each group R is an alkoxy group having 1 to 4 carbon atoms.

The invention provides a process characterised in that each group R is an ethoxy group.

The invention provides a process characterised in that a=3.

The invention provides a process characterised in that the polymeric material is a diene elastomer.

The invention provides a diene elastomer composition comprising a diene elastomer, a hydrolysable silane and a curing agent for the diene elastomer, characterised in that the hydrolysable silane is a hydrolysable silane of the formula

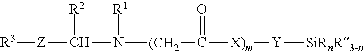

wherein each R represents a hydrolysable group; each R″ represents a hydrocarbyl group having 1 to 8 carbon atoms; n=1 to 3; Y represents a divalent organic spacer linkage having 1 to 20 carbon atoms; X represents —O— or —NH—; m=0 or 1; R² represents hydrogen or a hydrocarbyl or substituted hydrocarbyl group having 1 to 8 carbon atoms; Z represents an oxygen or sulphur atom; R³ represents a hydrocarbyl or substituted hydrocarbyl group having 1 to 20 carbon atoms; and R¹ represents a hydrocarbyl or substituted hydrocarbyl group having 1 to 20 carbon atoms other than a group of the formula R³—Z—CH(R²)— as defined above.

The invention provides a diene elastomer composition comprising a diene elastomer, a hydrolysable silane and a curing agent for the diene elastomer, characterised in that the hydrolysable silane is a hydrolysable silane of the formula G—OC(O)-(Az)-J wherein G and J each represent a hydrocarbyl or substituted hydrocarbyl group having 1 to 40 carbon atoms, at least one of G and J being a group of the formula RaR″3-aSi-A in which R represents a hydrolysable group; R″ represents a hydrocarbyl group having 1 to 8 carbon atoms; a has a value in the range 1 to 3 inclusive; and A represents a divalent organic spacer linkage having at least one carbon atom.

The invention provides a diene elastomer composition characterised in that the hydrolysable silane is present at 0.5 to 15.0% by weight based on the diene elastomer.

The invention provides a diene elastomer composition characterised in that a filler is present in the composition, whereby the hydrolysable silane acts as a coupling agent between the filler and the diene elastomer.

The invention provides a diene elastomer composition characterised in that the filler is silica.

The invention provides a diene elastomer composition characterised in that the curing agent for the diene elastomer is sulfur or a sulfur compound.

The invention provides a process for the production of a rubber article characterized in that a diene elastomer composition is shaped and cured.

The invention provides a process characterised in that the elastomer composition is cured at a temperature in the range 130° C. to 180° C.

The invention provides the use of a hydrolysable silane of the formula

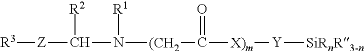

wherein each R represents a hydrolysable group; each R″ represents a hydrocarbyl group having 1 to 8 carbon atoms; n=1 to 3; Y represents a divalent organic spacer linkage having 1 to 20 carbon atoms; X represents —O— or —NH—; m=0 or 1; R² represents hydrogen or a hydrocarbyl or substituted hydrocarbyl group having 1 to 8 carbon atoms; Z represents an oxygen or sulphur atom; R³ represents a hydrocarbyl or substituted hydrocarbyl group having 1 to 20 carbon atoms; and R¹ represents a hydrocarbyl or substituted hydrocarbyl group having 1 to 20 carbon atoms other than a group of the formula R³—Z—CH(R²)— as defined above; as a coupling agent for a diene elastomer composition containing a filler.

The invention provides the use of a hydrolysable silane of the formula G—OC(O)-(Az)-J wherein G and J each represent a hydrocarbyl or substituted hydrocarbyl group having 1 to 40 carbon atoms, at least one of G and J being a group of the formula RaR″3-aSi-A in which R represents a hydrolysable group; R″ represents a hydrocarbyl group having 1 to 8 carbon atoms; a has a value in the range 1 to 3 inclusive; and A represents a divalent organic spacer linkage having at least one carbon atom; as a coupling agent for a diene elastomer composition containing a filler.

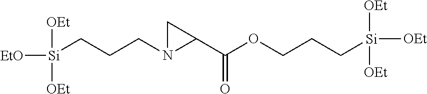 [SMILES: CCO[Si](CCCOC(=O)C1CN1CCC[Si](OCC)(OCC)OCC)(OCC)OCC]

Detailed synthesis of N-(3-triethoxysilylpropyl)aziridine-2-(3-triethoxysilylpropyl)carboxylate. A 500 ml two necked round bottom flask, fitted with a condenser, nitrogen sweep and magnetic stirrer, was charged with 23.4 g 3-aminopropyltriethoxysilane, 27.8 g triethylamine and 160 ml toluene and inerted with nitrogen. To this ice-cold mixture was added drop-wise a solution of 46.0 g (3-triethoxysilylpropyl)-2,3-dibromopropionate in 160 ml toluene. Mixture was refluxed for 6 hours and solids filtered off over diatomaceous earth. Solvent and volatiles were removed in vacuo affording the aziridine as a light orange liquid. Formation of the aziridine ring was confirmed by nuclear magnetic resonance spectroscopy.

### Silane 2

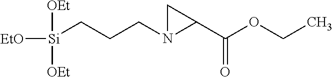 [SMILES: CCOC(=O)C1CN1CCC[Si](OCC)(OCC)OCC]

Detailed synthesis of N-(3-triethoxysilylpropyl)aziridine-2-ethylcarboxylate. A 500 ml two necked round bottom flask, fitted with a condenser, nitrogen sweep and magnetic stirrer, was charged with 23.4 g 3-aminopropyltriethoxysilane, 27.8 g triethylamine and 160 ml toluene and inerted with nitrogen. To this ice-cold mixture was added drop-wise a solution of 27.4 g ethyl-2,3-dibromopropionate in 160 ml toluene. Mixture was refluxed for 6 hours and solids filtered off over diatomaceous earth. Solvent and volatiles were removed in vacuo affording the aziridine as a light orange liquid. Formation of the aziridine ring was confirmed by nuclear magnetic resonance spectroscopy.

### EXAMPLES 1 AND 2

Rubber goods were prepared according to the procedure described below for example 1, 2 and comparative examples C1a, using the ingredients described below.

The amounts expressed in parts per hundred parts of rubber (phr) are described in table 1.
NR TSR 10, CV60—Natural rubber Technical Standard Rubber, purity grade 10, Constant viscosity (CV) 60 m.u. (Mooney unit)
Silica—Zeosil® 1165MP from Rhodia
Silane 1—Bis-(triethoxysilylpropyl)-tetrasulfane—Z-6940 from Dow Corning
Silane 2—N-3-triethoxysilylpropyl-2-carboethoxy-Aziridine
Silane 3—N-3-triethoxysilylpropyl-2-carboxypropyltriethoxysilane-Aziridine
ACST—Stearic Acid
ZnO—Zinc Oxide
6PPD—N-1,3-dimethylbutyl-N-phenyl-para-phenylenediamine from Rhein Chemie
S—Elemental sulphur from Sigma Aldrich
CBS—N-cyclohexyl-2-benzothiazyl sulfenamide (“Santocure® CBS” from Flexsys)
N234—Conventional carbon black according to ASTM D1765
DPG 80%—diphenylguanidine supported on EPDM at 80% active material from Rhein Chemie (Vulkanox® 4020/LG)

In a comparative example C1a, the silane 1 was used as reference coupling system well known by those skilled in the art for silica and diene elastomers.

In example 1 and 2, silane 1 was replaced by an equimolar quantity of silane 2 or 3.

TABLE 1

| Example | 1 | 2 | C1Aa |
|---|---|---|---|
| NR SMR 10 CV60 | 100.00 | 100.00 | 100.00 |
| Silane 1 | | | 5.00 |
| Silane 2 | 6.2 | | |
| Silane 3 | | 4.8 | |
| Silica - Z1165MP | 57.00 | 56.50 | 57.00 |
| ACST | 2.50 | 2.50 | 2.50 |
| ZnO | 3.00 | 3.00 | 3.00 |
| 6PPD | 2.00 | 2.00 | 2.00 |
| S | 2.05 | 2.05 | 2.00 |
| DPG 80% | | | 0.50 |
| CBS | 2.16 | 2.16 | 1.80 |

During a first non-productive phase, the reaction of the natural rubber, filler and when present silane was carried out using thermomechanical kneading in a Banbury mixer. The procedure was as shown in Table 2, which indicates the time of addition of various ingredients. The temperature at the end of mixing was measured inside the rubber after dumping it from the mixer.

TABLE 2

| Time (seconds) | 0 | 60 | 90 | 150 | 360 |
|---|---|---|---|---|---|
| Ingredient | Natural | ⅔ Filler | ⅓ filler | Ram | End |
| | rubber | (Silane) | | opening | mixing |
| Mixer internal probe | 80 | 90 | 100 | 160 | 155-165 |
| indicative | | | | | |
| temperature (° C.) | | | | | |

During a second non-productive phase stearic acid, zinc oxide and 6PPD were added to the obtained compound from the first non-productive phase. The mixing was carried out using thermomechanical kneading in a Banbury mixer. The procedure was as shown in Table 3, which indicates the time of addition of various ingredients and the estimated temperature of the mixture at that time.

TABLE 3

| Time (seconds) | 0 | 30 | 300 |
|---|---|---|---|
| Ingredient | Natural | ZnO | End |
| | rubber | AcSt | mixing |
| | | 6PPD | |
| Mixer internal probe | 80 | 90 | 155-165 |
| indicative | | | |
| temperature (° C.) | | | |

The modified natural rubber composition thus produced was milled on a two-roll mill at a temperature of about 70° C. during which milling the curing agents were added (productive phase). The mixing procedure for the productive phase is shown in Table 4.

TABLE 4

| | Number | Roll | |
|---|---|---|---|
| 2 roll mill | of | distance | |
| process step | passes | (mm) | Time/action |
| Heating up rubber | 5 | 4.0 | NA |
| | 1 | 3.5 | NA |
| | 1 | 3.0 | NA |
| | 1 | 2.5 | NA |
| Mixing rubber | NA | 2-2.4 | Form a mantle around one roll |
| and additives | | | add curing additives within 2.0 |
| | | | minutes |
| | | | cut and turn sheet regularly |
| | | | Stop after 6.0 minutes |
| Sheet formation | 3 | 2.5 | roll up |
| | 2 | 5.1 | Roll on first pass 3-ply for |
| | | | second |
| | 1 | 2.3-2.5 | For final sheet for cutting, |
| | | | moulding and curing |

The modified rubber sheet produced was tested as follows. The results of the tests are shown in Table X below.

The rheometry measurements were performed at 160° C. using an oscillating chamber rheometer (i.e., Advanced Plastic Analyzer) in accordance with Standard ISO 3417:1991 (F). The change in rheometric torque over time describes the course of stiffening of the composition as a result of the vulcanization reaction. The measurements are processed in accordance with Standard ISO 3417:1991(F). Minimum and maximum torque values, measured in deciNewtonmeter (dNm) are respectively denoted ML and MH time at α% cure (for example 5%) is the time necessary to achieve conversion of α% (for example 5%) of the difference between the minimum and maximum torque values. The difference, denoted MH−ML, between minimum and maximum torque values is also measured. In the same conditions the scorching time for the rubber compositions at 160° C. is determined as being the time in minutes necessary to obtain an increase in the torque of 2 units, above the minimum value of the torque (‘Time@2dNm scorch S’).

The tensile tests were performed in accordance with ISO Standard ISO37:1994(F) using tensile specimen ISO 37—type 2. The nominal stress (or apparent stresses, in MPa) at 10% elongation (M10), 100% elongation (M100) and elongation (M250 or M300) are measured at 10%, 100% and 250% or 300% of elongation. Breaking stresses (in MPa) are also measured. Elongation at break (in %) was measured according to Standard ISO 37. High values of Elongation at break are preferred. Preferably the Elongation at break is at least 300%. All these tensile measurements are performed under normal conditions of temperature and relative humidity in accordance with ISO Standard ISO 471. The ratio of M300 to M100 correlates with tread wear resistance of a tyre made from the rubber composition, with an increase in M300/M100 ratio indicating potential better tread wear resistance.

The dynamic properties were measured on a viscoanalyser (Metravib VA4000), in accordance with ASTM Standard D5992-96.
Strain sweep: The response of a sample of vulcanized composition (thickness of 2.5 mm and a cross-section of 40 mm²), subjected to an alternating single sinusoidal shearing stress, at a frequency of 10 Hz, under a controlled temperature of 55° C. is recorded. Scanning is performed at amplitude of deformation of 0.1 to 50% the maximum observed value of the loss factor tan d is recorded, the value being denoted tan δ 6%. The tan δ 6% value is well correlated to the rolling resistance of the tire, the lower the tan δ 6% the lower the rolling resistance is, the better the tire performance will be. G′₀ is the elastic modulus measured at very low strain, when the behaviour is linear with the stress. G′ₘₐₓ is the elastic modulus at 50% strain. Dynamical properties have been recorded after a first strain sweep (G′₀) from 0.1 to 50%, then the second strain sweep from 50% to 0.1% has been also recorded. The difference between the modulus at first strain sweep and the modulus after the return to low strain (G′₀ return) is denoted ΔG′₀ which is well correlated to the handling stability of the tire under stress. The difference between G′₀ return and G′ₘₐₓ after the second strain sweep is denoted ΔG′ return. The tan δ 6%, second strain sweep value corresponds to the maximum of the loss factor tan (δ) during the second strain sweep. A reduction in both tan δ 6% and tan δ 6%, second strain sweep is well correlated to a decrease in the rolling resistance of a tire manufactured from the rubber composition.
Temperature sweep: The response of a sample of vulcanized composition (thickness of 2.5 mm, height of 14 mm and length of 4.0 mm), subjected to an alternating single sinusoidal shearing stress, at a frequency of 10 Hz, under a controlled displacement of 1.25 micron. The sample is placed at room temperature and cooled down to −100° C. with a rate of 5° C./min. The temperature is then stabilised at −100° C. for 20 minutes to allow the sample to be at an equilibrium temperature state. The temperature is then increased up to 100° C. at a rate of 5° C./min. The loss factor and the stiffness, giving the modulus and the tan (δ). The tan δₘₐₓ and/or the value at 0° C. (tan δ_{0° C.}) is related to the wet skid performances. An increase in the tan δₘₐₓ and in the tan (δ) value at 0° C. (tan δ_{0° C.}) is indicative of improved wet skid performance.

The Shore A hardness was measured according to ASTM D2240-02b.

TABLE 5

| Example | 1 | 2 | C1a |
|---|---|---|---|
| Mmax (m.u.) | 67.5 | 60.2 | 71.1 |
| ML1 + 4 (m.u.) | 40.1 | 41.0 | 48.4 |
| ML (dNm) | 0.9 | 1.0 | 1.4 |
| MH (dNm) | 15.3 | 14.1 | 14.7 |
| MH − ML (dNm) | 14.3 | 13.1 | 13.4 |
| G′₀ (Pa) | 3.64 | 2.51 | 2.40 |
| G′ₘₐₓ (Pa) | 1.275 | 1.033 | 1.071 |
| ΔG′ (Pa) | 2.369 | 1.481 | 1.331 |
| Tan δ 6%, 2nd strain sweep | 0.103 | 0.090 | 0.071 |
| Tg (° C.) | −42.65 | −42.1 | −40.85 |
| Tan δ_{0° C.} | 0.153 | 0.162 | 0.172 |
| Tan δₘₐₓ | 1.018 | 1.089 | 1.123 |
| M100 (MPa) | 3.8 | 3.2 | 3.4 |
| M300 (MPa) | 18.6 | 17.2 | 17.2 |
| M300/M100 | 4.9 | 5.3 | 5.1 |
| Tensile break (MPa) | 29.4 | 29.9 | 28.8 |
| Elong max (%) | 453 | 480 | 472 |
| Shore A | 60 | 57 | 56 |

For example 1 and 2 MH−ML value were close to comparative example C1a to allow direct comparison of reinforcement capacity linked to silane and its coupling ability.

For both example 1 and 2 M300 value were close or higher than comparative example C1a showing the good ability of the silane to couple with Natural rubber.

For example 2, all performances were very close to comparative example C1a clearly showing ability for this type of silane to couple well with Natural Rubber.

For example 1 the G′0 results, the ΔG′, Shore A results were significantly higher than for comparative example C1a showing ability of this silane to lead to higher reinforcement. This higher reinforcement could lead to a potential to reduce silica content for improving final performances of the compound made with silane 2.

### Silane 4

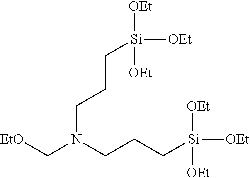 [SMILES: CCOCN(CCC[Si](OCC)(OCC)OCC)CCC[Si](OCC)(OCC)OCC]

Detailed synthesis of N-(ethoxymethyl)-N,N-bis(3-triethoxysilylpropyl)amine. A 1 L two necked round bottom flask, fitted with a condenser, nitrogen sweep and magnetic stirrer, was charged with 343.1 g of N,N-bis(3-triethoxysilylpropyl)amine, 24.2 g paraformaldehyde and 200 mL ethanol. The suspension was heated to 80° C. while stirring under nitrogen atmosphere. Ethanol reflux was maintained for less than 5 min, until complete disappearance of solid particles in the reaction mixture before ethanol was removed in vacuo. Final product was isolated with 99+% purity and 95% yield. Both formation of the ethoxymethylamine structure and preservation of the triethoxysilane fragment were confirmed by nuclear magnetic resonance.

### EXAMPLE 3

Rubber goods were prepared according to the procedure described below for example 3 and comparative examples C1b, using the ingredients described below.

The amounts expressed in parts per hundred parts of rubber (phr) are described in table 1.
NR TSR 10, CV60—Natural rubber Technical Standard Rubber, purity grade 10, Constant viscosity (CV) 60 m.u. (Mooney unit)
Silica—Zeosil® 1165MP from Rhodia
Silane 1—Bis-(triethoxysilylpropyl)-tetrasulfane—Z-6940 by Dow Corning
Silane 4—bis-(triethoxysilylpropyl)-amine-N-methyl-ethylether
ACST—Stearic Acid
ZnO—Zinc Oxide
6PPD—N-1,3-dimethylbutyl-N-phenyl-para-phenylenediamine from Rhein Chemie
S—Elemental sulphur from Sigma Aldrich
CBS—N-cyclohexyl-2-benzothiazyl sulfenamide (“Santocure® CBS” from Flexsys)
N234—Conventional carbon black according to ASTM D1765
DPG 80%—diphenylguanidine supported on EPDM at 80% active material from Rhein Chemie (Vulkanox® 4020/LG)

In a comparative example C1b, silane 1 was used as reference coupling system well known by those skilled in the art for silica and diene elastomers.

In example 3 silane 1 was replaced by an equimolar quantity of silane 4

TABLE 6

Example

| | C1b | 3 |
|---|---|---|
| Ingredients | phr | phr |
| Natural Rubber | 100 | 100 |
| Silica | 60 | 56.5 |
| Silane 1 | 5.2 | |
| Silane 4 | | 4.7 |
| ACST | 2.5 | 2.5 |
| ZnO | 3.0 | 3.0 |
| 6PPD | 2.0 | 2.0 |
| CBS | 1.8 | 2.16 |
| DPG 80% | 0.5 | |
| S | 1.5 | 2.05 |

During a first non-productive phase, the reaction of the natural rubber, filler and when present silane was carried out using thermomechanical kneading in a Banbury mixer. The procedure was as shown in Table 2, which indicates the time of addition of various ingredients. The temperature at the end of mixing was measured inside the rubber after dumping it from the mixer.

TABLE 7

| Time (seconds) | 0 | 60 | 90 | 150 | 360 |
|---|---|---|---|---|---|
| Ingredient | Natural | ⅔ Filler | ⅓ filler | Ram | End |
| | rubber | (Silane) | | opening | mixing |
| Mixer internal probe | 80 | 90 | 100 | 160 | 155-165 |
| indicative | | | | | |
| temperature (° C.) | | | | | |

During a second non-productive phase stearic acid, zinc oxide and 6PPD were added to the obtained compound from the first non-productive phase. The mixing was carried out using thermomechanical kneading in a Banbury mixer. The procedure was as shown in Table 3, which indicates the time of addition of various ingredients and the estimated temperature of the mixture at that time.

TABLE 8

| Time (seconds) | 0 | 30 | 300 |
|---|---|---|---|
| Ingredient | Natural | ZnO | End |
| | rubber | AcSt | mixing |
| | | 6PPD | |
| Mixer internal probe | 80 | 90 | 155-165 |
| indicative | | | |
| temperature (° C.) | | | |

The modified natural rubber composition thus produced was milled on a two-roll mill at a temperature of about 70° C. during which milling the curing agents were added (productive phase). The mixing procedure for the productive phase is shown in Table 4.

TABLE 9

| | Number | Roll | |
|---|---|---|---|
| 2 roll mill | of | distance | |
| process step | passes | (mm) | Time/action |
| Heating up rubber | 5 | 4.0 | NA |
| | 1 | 3.5 | NA |
| | 1 | 3.0 | NA |
| | 1 | 2.5 | NA |
| Mixing rubber | NA | 2-2.4 | Form a mantle around one roll |
| and additives | | | add curing additives within 2.0 |
| | | | minutes |
| | | | cut and turn sheet regularly |
| | | | Stop after 6.0 minutes |
| Sheet formation | 3 | 2.5 | roll up |
| | 2 | 5.1 | Roll on first pass 3-ply for |
| | | | second |
| | 1 | 2.3-2.5 | For final sheet for cutting, |
| | | | moulding and curing |

The modified rubber sheet produced was tested as follows. The results of the tests are shown in Table X below.

The rheometry measurements were performed at 160° C. using an oscillating chamber rheometer (i.e., Advanced Plastic Analyzer) in accordance with Standard ISO 3417:1991 (F). The change in rheometric torque over time describes the course of stiffening of the composition as a result of the vulcanization reaction. The measurements are processed in accordance with Standard ISO 3417:1991(F). Minimum and maximum torque values, measured in deciNewtonmeter (dNm) are respectively denoted ML and MH time at α% cure (for example 5%) is the time necessary to achieve conversion of α% (for example 5%) of the difference between the minimum and maximum torque values. The difference, denoted MH−ML, between minimum and maximum torque values is also measured. In the same conditions the scorching time for the rubber compositions at 160° C. is determined as being the time in minutes necessary to obtain an increase in the torque of 2 units, above the minimum value of the torque (‘Time@2dNm scorch S’).

The tensile tests were performed in accordance with ISO Standard ISO37:1994(F) using tensile specimen ISO 37—type 2. The nominal stress (or apparent stresses, in MPa) at 10% elongation (M10), 100% elongation (M100) and elongation (M250 or M300) are measured at 10%, 100% and 250% or 300% of elongation. Breaking stresses (in MPa) are also measured. Elongation at break (in %) was measured according to Standard ISO 37. High values of Elongation at break are preferred. Preferably the Elongation at break is at least 300%. All these tensile measurements are performed under normal conditions of temperature and relative humidity in accordance with ISO Standard ISO 471. The ratio of M300 to M100 correlates with tread wear resistance of a tyre made from the rubber composition, with an increase in M300/M100 ratio indicating potential better tread wear resistance.

The dynamic properties were measured on a viscoanalyser (Metravib VA4000), in accordance with ASTM Standard D5992-96.
Strain sweep: The response of a sample of vulcanized composition (thickness of 2.5 mm and a cross-section of 40 mm²), subjected to an alternating single sinusoidal shearing stress, at a frequency of 10 Hz, under a controlled temperature of 55° C. is recorded. Scanning is performed at amplitude of deformation of 0.1 to 50% the maximum observed value of the loss factor tan d is recorded, the value being denoted tan δ 6%. The tan δ 6% value is well correlated to the rolling resistance of the tire, the lower the tan δ 6% the lower the rolling resistance is, the better the tire performance will be. G′₀ is the elastic modulus measured at very low strain, when the behaviour is linear with the stress. G′ₘₐₓ is the elastic modulus at 50% strain. Dynamical properties have been recorded after a first strain sweep (G′₀) from 0.1 to 50%, then the second strain sweep from 50% to 0.1% has been also recorded. The difference between the modulus at first strain sweep and the modulus after the return to low strain (G′₀ return) is denoted ΔG′₀ which is well correlated to the handling stability of the tire under stress. The difference between G′₀ return and G′ₘₐₓ after the second strain sweep is denoted ΔG′ return. The tan δ 6%, second strain sweep value corresponds to the maximum of the loss factor tan (δ) during the second strain sweep. A reduction in both tan δ 6% and tan δ 6%, second strain sweep is well correlated to a decrease in the rolling resistance of a tire manufactured from the rubber composition.
Temperature sweep: The response of a sample of vulcanized composition (thickness of 2.5 mm, height of 14 mm and length of 4.0 mm), subjected to an alternating single sinusoidal shearing stress, at a frequency of 10 Hz, under a controlled displacement of 1.25 micron. The sample is placed at room temperature and cooled down to −100° C. with a rate of 5° C./min. The temperature is then stabilised at −100° C. for 20 minutes to allow the sample to be at an equilibrium temperature state. The temperature is then increased up to 100° C. at a rate of 5° C./min. The loss factor and the stiffness, giving the modulus and the tan (δ). The tan δₘₐₓ and/or the value at 0° C. (tan δ_{0° C.}) is related to the wet skid performances. An increase in the tan δₘₐₓ and in the tan (δ) value at 0° C. (tan δ_{0° C.}) is indicative of improved wet skid performance.

The Shore A hardness was measured according to ASTM D2240-02b.

TABLE 10

| Example | C1b | 3 |
|---|---|---|
| Mmax (M.U.) | 62 | 63 |
| ML1 + 4 (M.U.) | 40 | 45 |
| ML (dNm) | 1.0 | 1.2 |
| MH (dNm) | 13.6 | 15.6 |
| MH − ML (dNm) | 12.6 | 14.5 |
| G′₀ (Pa) | 2.05 | 2.33 |
| G′ₘₐₓ (Pa) | 0.96 | 0.99 |
| ΔG′ (Pa) | 1.09 | 1.34 |
| Tan δ 6%, second strain sweep | 0.094 | 0.085 |
| Tg (° C.) | −44.5 | −43.4 |
| Tan δ_{0° C.} | 0.180 | 0.145 |
| Tan δₘₐₓ | 1.204 | 1.164 |
| M100 (MPa) | 2.5 | 2.6 |
| M300 (MPa) | 14.6 | 14.8 |
| M300/M100 | 5.7 | 5.7 |
| Tensile break (MPa) | 26.6 | 28.9 |
| Elong max (%) | 494 | 510 |
| Shore A | 56 | 54 |

In example 3, all performances were comparable to comparative example C1b clearly showing the good ability of silane 4 to couple well with Natural Rubber.

### EXAMPLES 4 AND 5

Rubber goods were prepared according to the procedure described below for example 4, 5 and comparative examples C1b, using the ingredients described below.

The amounts expressed in parts per hundred parts of rubber (phr) are described in table 1.
NR TSR 10, CV60—Natural rubber Technical Standard Rubber, purity grade 10, Constant viscosity (CV) 60 m.u. (Mooney unit)
Silica—Zeosil® 1165MP from Rhodia
Silane 1—Bis-(triethoxysilylpropyl)-tetrasulfane—Z-6940 by Dow Corning
Silane 4—bis-(triethoxysilylpropyl)-amine-N-methyl-ethylether
Silane 5—triethoxysilylpropyl-amine—Z-6011 by Dow Corning
ACST—Stearic Acid
ZnO—Zinc Oxide
6PPD—N-1,3-dimethylbutyl-N-phenyl-para-phenylenediamine from Rhein Chemie
S—Elemental sulphur from Sigma Aldrich
CBS—N-cyclohexyl-2-benzothiazyl sulfenamide (“Santocure® CBS” from Flexsys)
N234—Conventional carbon black according to ASTM D1765
DPG 80%—diphenylguanidine supported on EPDM at 80% active material from Rhein Chemie (Vulkanox® 4020/LG)
SR351—trimethylolpropan-triacrylate from Sartomer

In a comparative example C1c and C1d, silane 1 was used as reference coupling system well known by those skilled in the art for silica and diene elastomers. In comparative example C1d curing package had been modified to reach a similar crosslinking speed and density than for example 4 and 5 to allow direct comparison of performances.

In example 4 and 5 silane 1 was replaced by an equimolar quantity of the association of silane 4 and 5—using a molar ratio 1 to 1 of silane 4 and silane 5. In example 5, SR351 had been added to limit rubber degradation during curing and improve performance compared to example 4.

TABLE 11

| Example | 4 | 5 | C1c | C1d |
|---|---|---|---|---|
| NR SMR 10 CV60 | 100.00 | 100.00 | 100.00 | 100.00 |
| Silane 1 | | | 5.00 | 5.00 |
| Silane 4 | 2.35 | 2.35 | | |
| Silane 5 | 2.08 | 2.08 | | |
| Silica - Z1165MP | 56.50 | 56.50 | 57.00 | 57.00 |
| ACST | 2.50 | 2.50 | 2.50 | 2.50 |
| ZnO | 3.00 | 3.00 | 3.00 | 3.00 |
| 6PPD | 2.00 | 2.00 | 2.00 | 2.00 |
| S | 2.15 | 2.15 | 2.00 | 2.00 |
| DPG 80% | | | 0.50 | 1.5 |
| CBS | 2.26 | 2.26 | 1.80 | 0.6 |
| SR351 | | 2 | | |

TABLE 12

| Example | 4 | 5 | C1c | C1d |
|---|---|---|---|---|
| ML (dNm) | 0.8 | 0.7 | 1.4 | 1.3 |
| MH (dNm) | 11.9 | 12.2 | 14.7 | 11.8 |
| Time@95% cure S′ (min) | 2.6 | 3.4 | 6.3 | 4.1 |
| MH − ML (dNm) | 11.1 | 11.5 | 13.4 | 10.6 |
| G′₀ (Pa) | 1.71 | 2.26 | 2.40 | 2.12 |
| G′ₘₐₓ (Pa) | 0.886 | 0.966 | 1.071 | 0.890 |
| ΔG′ (Pa) | 0.821 | 1.295 | 1.331 | 1.229 |
| Tan δ 6%, 2nd strain sweep | 0.065 | 0.072 | 0.071 | 0.100 |
| Tg (° C.) | −43.2 | −43.65 | −40.85 | −42.7 |
| Tan δ_{0° C.} | 0.146 | 0.163 | 0.172 | 0.170 |
| Tan δₘₐₓ | 1.509 | 1.334 | 1.123 | 1.142 |
| M100 (MPa) | 2.4 | 2.7 | 3.4 | 2.4 |
| M300 (MPa) | 16.8 | 17.6 | 17.2 | 13.0 |
| M300/M100 | 6.9 | 6.5 | 5.1 | 5.4 |
| Tensile break (MPa) | 27.9 | 28.7 | 28.8 | 27.9 |
| Elong max (%) | 440 | 439 | 472 | 540 |
| Shore A | 50 | 52 | 56 | 52 |

In example 4 and example 5, even having a lower crosslinking density represented by MH−ML, M300 values were very close to comparative example C1, M300 values were significantly higher than those of comparative example C1d with adjusted crosslinking density. This clearly showed the ability of this silane to lead to higher reinforcement capacity.

As compared to comparative example C1c, both example 4 and example 5 showed significantly better performances: tan d 6% showed a reduced rolling resistance, M300 and M300/M100 showed a better abrasion resistance of compound and tan d max shows a better wet grip performance

Addition of SR351 in example 5 lead to increased G′0 and ΔG′ leading to a stronger network formation and better handling performances.

1. A process for modifying a polymeric material having a carbon backbone containing carbon-to-carbon unsaturation by reaction with a hydrolysable silane, characterised in that the hydrolysable silane is selected from a silane of the formula (1) 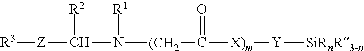
wherein each R represents a hydrolysable group; each R″ represents a hydrocarbyl group having 1 to 8 carbon atoms; n=1 to 3; Y represents a divalent organic spacer linkage having 1 to 20 carbon atoms; X represents —O— or —NH—; m=0 or 1; R² represents hydrogen or a hydrocarbyl or substituted hydrocarbyl group having 1 to 8 carbon atoms; Z represents an oxygen or sulphur atom; R³ represents a hydrocarbyl or substituted hydrocarbyl group having 1 to 20 carbon atoms; and R¹ represents a hydrocarbyl or substituted hydrocarbyl group having 1 to 20 carbon atoms other than a group of the formula R³—Z—CH(R²)— as defined above or a silane of formula (2) G-OC(O)-(Az)-J wherein G and J each represent a hydrocarbyl or substituted hydrocarbyl group having 1 to 40 carbon atoms, at least one of G and J being a group of the formula RaR″₃₋ₐSi-A in which R represents a hydrolysable group; R″ represents a hydrocarbyl group having 1 to 8 carbon atoms; a has a value in the range 1 to 3 inclusive; Az represents an aziridine ring bonded to the group J through its nitrogen atom; and A represents a divalent organic spacer linkage having at least one carbon atom or a mixture thereof.

2. A process according to claim 1, characterised in that Z represents an oxygen atom and R³ represents a hydrocarbyl group having 1 to 8 carbon atoms.

3. A process according to claim 1, characterised in that Z represents an oxygen atom and R³ represents a group of the formula —((CH2)aO)b-R4 wherein a=1 to 3; b=1 to 6; and R⁴ represents hydrogen or a hydrocarbyl or substituted hydrocarbyl group having 1 to 20 carbon atoms.

4. A process according to claim 1, characterised in that Z represents a sulphur atom and R³ represents a group of the formula —Y″—SiRpR″₃₋ₚ wherein Y″ represents a divalent organic spacer linkage having 1 to 20 carbon atoms; each R represents a hydrolysable group; each R″ represents a hydrocarbyl group having 1 to 8 carbon atoms; and p=1 to 3.

5. A process according to claim 1, characterised in that R¹ represents a hydrocarbyl group having 1 to 8 carbon atoms.

6. A process according to claim 1, characterised in that R¹ represents a group of the formula —Y*—SiR_{g}R″_{3-g} wherein Y* represents a divalent organic spacer linkage having 1 to 20 carbon atoms; each R represents a hydrolysable group; each R″ represents a hydrocarbyl group having 1 to 8 carbon atoms; and q=1 to 3.

7. A process according to claim 1, characterised in that R¹ represents a group of the formula 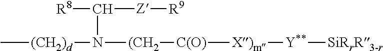
wherein d=1 to 8; R⁸ represents hydrogen or a hydrocarbyl or substituted hydrocarbyl group having 1 to 8 carbon atoms; Z represents an oxygen or sulphur atom; R⁹ represents a hydrocarbyl or substituted hydrocarbyl group having 1 to 20 carbon atoms; X″ represents —O— or —NH—; m″=0 or 1; Y** represents a divalent organic spacer linkage having 1 to 20 carbon atoms; each R represents a hydrolysable group; each R″ represents a hydrocarbyl group having 1 to 8 carbon atoms; and r=1 to 3.

8. A process according to claim 1, characterised in that R1 represents a group of the formula —(CH₂)ₑ—C(O)OR¹⁰ wherein e=1 to 8; and R¹⁰ represents a hydrocarbyl group having 1 to 8 carbon atoms.

9. A process according to claim 1, characterised in that R² represents hydrogen.

10. A process according to claim 1, characterised in that the hydrolysable silane has the formula RₐR″₃₋ₐSi-A-OC(O)-(Az)-J wherein R, R″, A, a and Az are defined as in claim 1 and J represents a hydrocarbyl or substituted hydrocarbyl group having 1 to 40 carbon atoms.

11. A process according to claim 1, characterised in that the hydrolysable silane has the formula G-OC(O)-(Az)-A-Si—RaR″₃₋ₐ wherein R, R″, A, a and Az are defined as in claim 1 and G represents a hydrocarbyl or substituted hydrocarbyl group having 1 to 40 carbon atoms.

12. A process according to claim 11, characterised in that the group G of the hydrolysable silane represents a substituted hydrocarbyl group which is the residue of a polyol having 2 to 6 alcohol groups, the group G being bonded to 1 to 6 groups of the formula —OC(O)-(Az)-A′-Si—R^{a}R″₃₋ₐ wherein R, R″, A, a and Az are defined as in claim 1.

13. A process according to claim 10, characterised in that each group R is an alkoxy group having 1 to 4 carbon atoms.

14. (canceled)

15. A process according to claim 1, characterised in that a=3, the polymeric material is a diene elastomer, or a=2 and the polymeric material is a diene elastomer.

16. (canceled)

17. A diene elastomer composition comprising a diene elastomer, a hydrolysable silane and a curing agent for the diene elastomer, characterised in that the hydrolysable silane is a hydrolysable silane of the formula 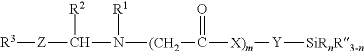
wherein each R represents a hydrolysable group; each R″ represents a hydrocarbyl group having 1 to 8 carbon atoms; n=1 to 3; Y represents a divalent organic spacer linkage having 1 to 20 carbon atoms; X represents —O— or —NH—; m=0 or 1; R² represents hydrogen or a hydrocarbyl or substituted hydrocarbyl group having 1 to 8 carbon atoms; Z represents an oxygen or sulphur atom; R³ represents a hydrocarbyl or substituted hydrocarbyl group having 1 to 20 carbon atoms; and R¹ represents a hydrocarbyl or substituted hydrocarbyl group having 1 to 20 carbon atoms other than a group of the formula R³—Z—CH(R²)— as defined above.

18. (canceled)

19. A diene elastomer composition according to claim 17, characterised in that the hydrolysable silane is present at 0.5 to 15.0% by weight based on the diene elastomer, a filler is present in the composition, whereby the hydrolysable silane acts as a coupling agent between the filler and the diene elastomer, or the hydrolysable silane is present at 0.5 to 15.0% by weight based on the diene elastomer and a filler is present in the composition, whereby the hydrolysable silane acts as a coupling agent between the filler and the diene elastomer.

20-21. (canceled)

22. A diene elastomer composition according to claim 17 characterised in that the curing agent for the diene elastomer is sulfur or a sulfur compound.

23. A process for the production of a rubber article characterized in that a diene elastomer composition according to claim 17 is shaped and cured.

24-26. (canceled)

27. A diene elastomer composition comprising a diene elastomer, a hydrolysable silane and a curing agent for the diene elastomer, characterised in that the hydrolysable silane is a hydrolysable silane of the formula G-OC(O)-(Az)-J wherein G and J each represent a hydrocarbyl or substituted hydrocarbyl group having 1 to 40 carbon atoms, at least one of G and J being a group of the formula RₐR″₃₋ₐSi-A in which R represents a hydrolysable group; R″ represents a hydrocarbyl group having 1 to 8 carbon atoms; a has a value in the range 1 to 3 inclusive; and A represents a divalent organic spacer linkage having at least one carbon atom.

28. A diene elastomer composition according to claim 27, characterised in that the hydrolysable silane is present at 0.5 to 15.0% by weight based on the diene elastomer, a filler is present in the composition, whereby the hydrolysable silane acts as a coupling agent between the filler and the diene elastomer, or the hydrolysable silane is present at 0.5 to 15.0% by weight based on the diene elastomer and a filler is present in the composition, whereby the hydrolysable silane acts as a coupling agent between the filler and the diene elastomer.
